(19) United States
(12) Patent Application Publication
(10) Pub. No.: US 2010/0100566 A1
(43) Pub. Date: Apr. 22, 2010

(54) Methods and Systems for Identifying the Fantasies of Users Based on Image Tagging

(76) Inventor: Andreas Hronopoulos, San Diego, CA (US)

Correspondence Address: KENYON & KENYON LLP, ONE BROADWAY, NEW YORK, NY, 10004, US

(21) Appl. No.: 12/642,576

(22) Filed: Dec. 18, 2009

Related U.S. Application Data
(63) Continuation of application No. 12/140,069, filed on Jun. 16, 2008.

(51) Int. Cl. G06F 17/30

(52) U.S. Cl. 707/784; 707/E17.059

(57) ABSTRACT

Systems and methods for receiving uploaded images from users depicting people. Users are allowed to tag the images as depicting certain attribute(s). Users are allowed to share the user uploaded content with other users, which may search and/or filter based on the provided tags. A preference profile is maintained for users, and preference values related to the image tags provided for uploaded images are maintained. A user's preference profile may be modified based on the tags associated with images uploaded by the user. A user's preference profile may be modified based on which images, uploaded by other users, are viewed by the user.

### CROSS-REFERENCE TO RELATED APPLICATION

This application is a continuation of and claims priority to U.S. patent application Ser. No. 12/140,069, filed on Jun. 16, 2008, the entire contents of which are expressly incorporated herein by reference.

### BACKGROUND

Providing content (e.g., video content) to users is a major industry. One way to sell more content to users or to increase the satisfaction of subscription users is to provide them content that is desirable to them, while at the same time minimizing the effort users need to spend to locate such content. For example, Amazon®, Netflix®, and Ebay®, well-known providers of various types of goods over the Internet, including videos, all provide some sort of automatic recommendations to users. For example, recommendations may be based on a user's purchase history and/or the purchase history of demographically similar users.

The adult entertainment industry makes up a significant portion of the online economy. Specifically, digital media adult entertainment (e.g., videos, pictures, cartoons, and similar) is a multi-billion dollar industry, which makes up a substantial portion of Internet traffic and commerce. Estimated total revenues for adult videos were greater than $12 billion in 2005. See “State of the U.S. Adult Video Industry”, Business Wire, Dec. 13, 2005.

It is additionally known that sexual fantasies are a healthy part of virtually all humans beyond a certain age. See Peter Doskoch, The Safest Sex, Psychology Today, September/October 1995 at 46 (also available at http://psychologytoday.com/articles/pto-1268.html). Research further indicates that fantasies of many kinds are normal and healthy. For example, even fantasies based on what would be considered socially deviant behavior are virtually never an indication of actual or future socially deviant behavior, and are quite normal. As a result, the adult entertainment industry produces videos, magazines, images, and other media geared towards specific fantasy genres. However, human fantasies are as diverse as the human population itself, and current fantasy based adult entertainment typically focuses on only one or a few attributes.

### SUMMARY

One example embodiment of the invention described in the incorporated reference may include a system and method for assisting users in identifying their fantasies and/or assisting users in identifying more specific versions (e.g. more satisfying versions) of their fantasies. The example embodiment may employ a host of techniques for identifying specific fantasies and/or details, examples of which are provided in the incorporated reference and may include building a fantasy profile for the user. The mere identification of a user fantasy may be a great benefit to the user. Additionally, once a fantasy is known, fantasy specific content and merchandise may be provided to the user, such as videos depicting actors playing fantasy specific roles. In addition to content, users may be matched with other users who desire to engage in fantasy specific role playing. Merchandise such as fantasy specific props and accessories may be offered as well.

Example embodiments of the present invention include additional tools for creating and refining a fantasy profile for a user. Example embodiments of the present invention may provide a computer database and applications for uploading and tagging images. While example embodiments may be described with reference to images, the features may equally apply to graphics, videos, and any other user content capable of being tagged by the user. The user may use the example embodiments to upload images of people and tag those images with one or more descriptive attributes. This content may then be shared with other users of the system, e.g., in the context of social networking and user profiles. A user may browse the other tagged content uploaded, and may search by one or more specific attributes.

### BRIEF DESCRIPTION OF THE DRAWINGS

FIG. 1 is an example system for image tagging, according to an example embodiment of the present invention.

FIG. 2 is an example method for image tagging, according to an example embodiment of the present invention.

FIG. 3 is an example system for image tagging and rating, according to an example embodiment of the present invention.

FIGS. 4A and 4B are example methods for image tagging and rating, according to an example embodiment of the present invention.

FIG. 5 is an example system for image uploading and profile manipulation, according to an example embodiment of the present invention.

### DETAILED DESCRIPTION OF EXAMPLE EMBODIMENTS

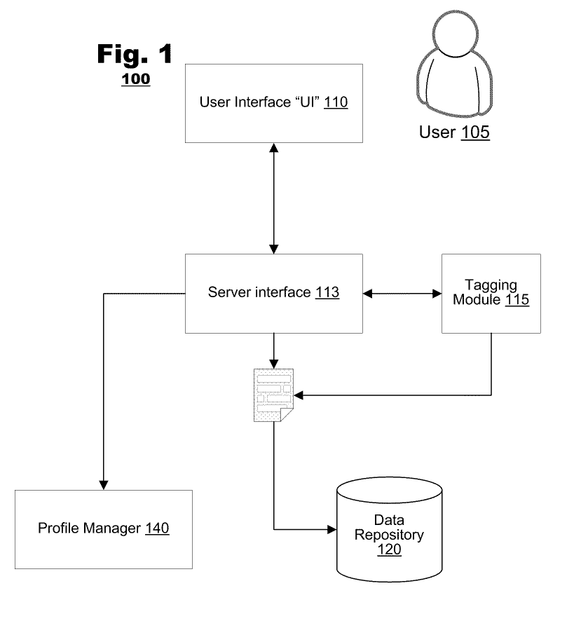

FIG. 1 illustrates an example system according to example embodiments of the present invention. The example system may have a user interface (“UI”) 110 to facilitate system-use by the user 105. The UI 110 may connect to a server via a network (e.g., server interface 113) and may receive a digital image from the user for uploading. Throughout, example embodiments may by illustrated with the specific implementation of “images,” but could also be implemented with any other data set, especially other visual media data sets, e.g., video, streaming content, graphics, pre-saved data, live-cast or real-time data, etc., and any combination of these or other data types. Further, server interface 113 may be in communication with a tagging module 115. The tagging module may have a predefined set of attribute tags, and may provide those to the UI for selection by the user. Additionally, the tagging module may allow for free-form entry and use one or more matching algorithms to standardize tags, or otherwise match related tags, such that related pictures are associated with each other in the example system. The image may have the selected/entered attribute tags encoded in meta-data or otherwise associated with the image. The tagged image may then be stored in a data repository 120. The server interface 113 may also be in communication with a profile manager 140, that manages user fantasy profiles according to example embodiments of the incorporated reference.

The user interface may reside on any number of devices. The UI may be on a personal computer, a smart phone, a cellular phone, a laptop, or any other device capable of implementing an embodiment of the present invention. Further, the UI may be a third party product e.g., a web-browser or email application with media attachments, or the UI may be an application specifically designed to include this feature, e.g., an application designed by the content provides/profile manager and installed by the user. Further, uploads may be identified by any number of identification methods known in the art, and registered with an associated preference profile.

Preference adjustments may occur in any number of ways. For example, the system may increment a counter for each attribute tagged in the image. The profile manager may then adjust a user profile based on the counters. For example, if a user uploads N (e.g., 10) pictures with a “long hair” attribute tagged, the profile manager may increase a preference selection for long hair stored in the user profile. Alternatively, the profile manager may increase the preference selection for long hair, based on the N uploads, if the current preference setting is below some threshold. In this way, if a user already has a 9 out of 10 score for a long hair preference, the 10 uploads are already expected from this user. However, if the user has a 1 out of 10 score, a refinement may be necessary via an incrementing. An example formula may be: if the number of uploads divided by a constant is greater than the current preference, then increment the current preference by some value.

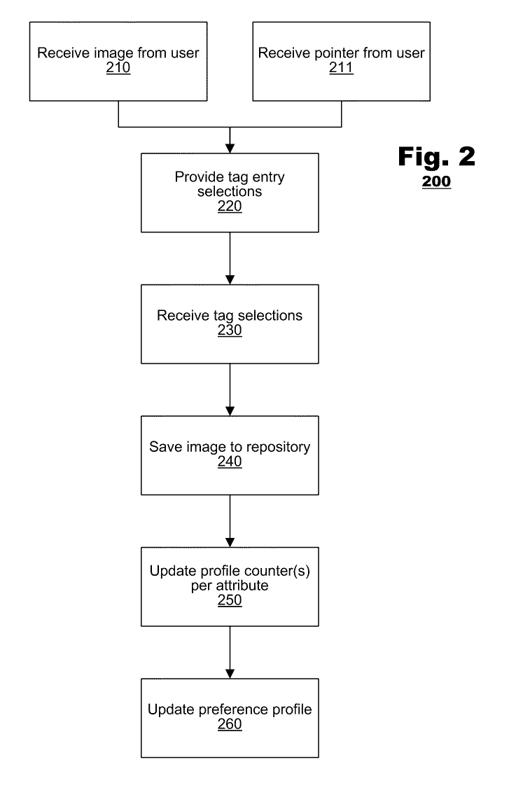

FIG. 2 illustrates an example method, according to an example embodiment of the present invention. At 210, the example method may receive an image to upload to a data repository of an example system (e.g., 120). The received image is not limited to the actual image data, and may alternatively be a pointer to that data (e.g., 211). For example, in this embodiment as well as the others, a user may send a URL or other link/pointer of an image, instead of the actual image. At 220, the example method may provide tag entry selections, or an alternative data-entry means capable to tagging the images with descriptive attribute data. At 230, the example method may receive selections or input data from the user about the attributes of the upload image. If a pointer is used, the system may or may not retrieve the image data, but may register the tag information associated with the pointer (e.g., “milf”), which may be part of the linked data or part of the link itself This data may be stored in the image meta-data, or in a separate associated data object. For example, the image may have a caption labeling it with the attribute, or the user may add this caption to the image or pointer (e.g., check out this cougar/blond/etc.). At 240, the tagged image may be stored to a data repository (e.g., 120). At 250, a counter may be incremented in the user profile for each attribute tagged in the image. At 260, a profile manager may then apply a formula to determine if the user upload should cause a change in the user preference profile, based on the tags in the image.

In addition to modifying a user preference profile based on image tags associated with images uploaded by the user, a user preference profile manager may modify a user preference profile based on images uploaded by other users. In this example embodiment, uploaded content may be made available to a larger online community of users, and the system may track the viewing habits of a particular user, in order to refine that user's preference profile. As is customary with user systems, control over these functions may be provided to the users. For example, a user may specify if uploaded content is to be shared, e.g. with no one, with other users, or with the whole world. A user may specify whether the system is permitted to adjust a preference profile based on uploads or viewing patterns, or may specify anonymous uploading and/or browsing of user images. A refined preference profile may assist in a more refined delivery of content, suggested content, and/or fantasy matching, according to example embodiments of the incorporated reference.

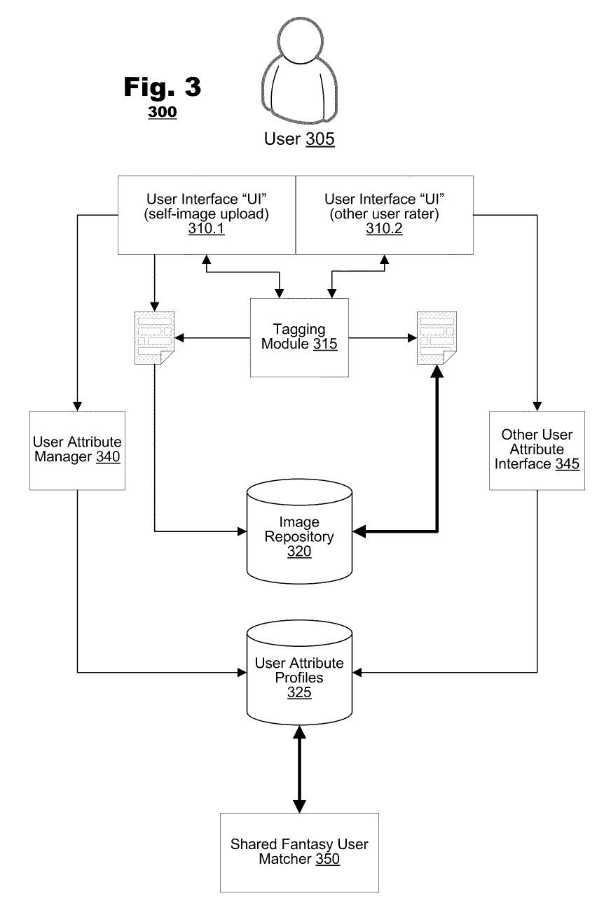

FIG. 3 illustrates another example system, according to an example embodiment of the present invention. FIG. 1 illustrates a system that may be designed primarily for uploading images of other people (e.g., other than the uploading user). FIG. 3 illustrates a system the may be designed primarily for uploading images of the uploading user. The system may include an interface 310, with a self-image upload function 310.1. This function may be identical to 110 with an added attribute tag or option function for “self” The tagging module 315 may allow the user to tag various attributes about themselves, such as height, age, most prominent feature, etc. These images may be stored in an image repository 320, which may be shared with other images, or stored in a separate location. The system may include a user attribute manager 340, which may adjust a user attribute profile 325, according to the tags selections made.

On the other side of UI 310, there may be a image rating interface 310.2, which a user may use to browse and tag/rate the images of other users. A user may browse the image repository 320, call up images, and add tags based on attributes noticed in the images, or rate attributes already tagged in the images. For example, an image may be tagged as having a person with “blue eyes” in the image. Another user, viewing this image, may be provided an opportunity to flag the image as incorrect (e.g., the eyes are actually brown), rate the image attribute (e.g., on a scale from 1 to 10), and/or add tags for other attributes. Based on the ratings received, and tags provided, the other user attribute interface 345 may modify the user attribute profile for the associated user (e.g., the user in the image), and store the modified value in the user attribute database 325. The system illustrated in FIG. 3, as with all example embodiments, may also be implemented with any other type of data, especially visual media data. Further, the UI may be presented on a user device (e.g., as illustrated in FIG. 1) and interface with a host computer.

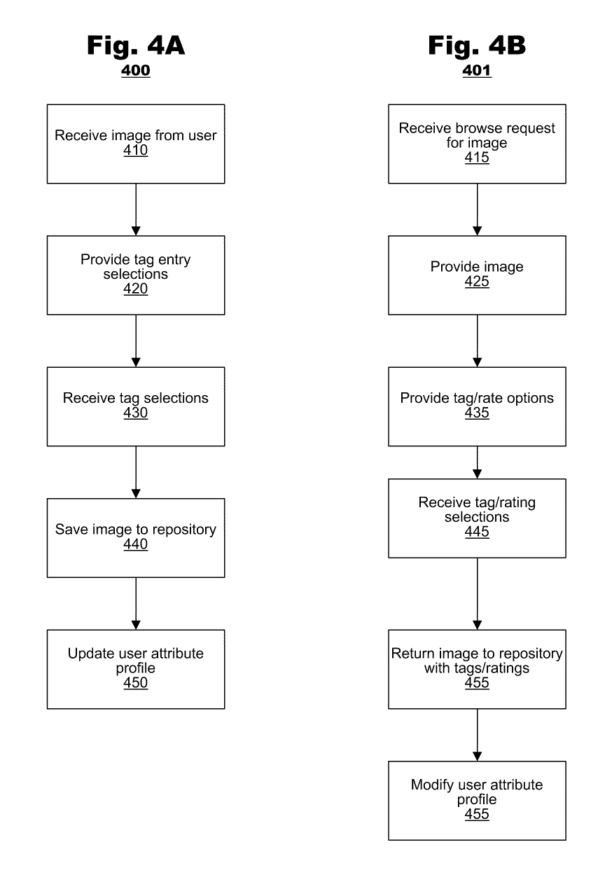

FIGS. 4A and 4B illustrate example procedures according to example embodiments of the present invention. FIG. 4A is generally similar to the example procedure of FIG. 2, but resulting in an update to a user attribute profile 450, instead of a user preference profile. These profiles may be stored in the same place (e.g., the same data structure) or may be stored separately. Additionally, the example procedure for uploading a self image may be the same procedure as other images, with additional tag data.

FIG. 4B may illustrate an example procedure for browsing images of users to update attribute profiles. At 415, the example procedure may receive a request from a user to browse one or more images. Image presentation methods are known, and any method for organizing and presenting images could be used. At 425, the example procedure may provide the image from an image database (e.g., 320). At 435, the example procedure may provide tag options to tag various attributes of the person in the image, and/or rating options to rate the various attributes already tagged (or implicitly tagged). At 445, the example procedure may receive the selected tags and/or ratings. At 455, the example procedure may return the image to the repository with the added tags/ratings. The tags and ratings may be stored with the image (e.g., in mete-data), or may be stored in association with the image (e.g., in a separate data structure with a reference to the image). Finally, at 455, the example procedure may modify the attribute profile of the user depicted in the image, according to the tags and ratings modified for the image.

Alternatively, tags and ratings may be recorded for a specific image, and action may be taken by the example systems and procedures only when a sufficient number of tags/ratings have been applied. For example, if an image gets just 1 “blue eyes” rating, it may be that no action is taken yet, but that tag is recorded in association with the image. Subsequently, upon the Nth (e.g. 10th) tag, an actual tag may be added to the image, and the user attribute profile may be modified. Additionally, example procedures may account for contrary data. For example, upon the 10th “blue eyes” tag, for an image that also has some number (e.g., 5) “brown eyes” tags, the example procedures may continue to wait before modifying the actual attribute profiles and image data. Formulas may be configured for translating tags and ratings by other users into attribute profile changes, and may be fully customizable by the system administrator.

The data provided by other users may be used to refine attribute data for a given user. The attribute profiles may be connected to a shared fantasy user profile module (e.g., 350). This module may assist in connecting users with reciprocal and complementary fantasies, as discussed in example embodiments of the incorporated reference. The example procedures of FIGS. 2, 4A, and 4B may allow for a better matching, by refining a user's preferences and refining a user's attributes (including an objective refining by other users). A user's attribute profile may be established by example procedures of the incorporated reference during the establishing of the profile, before any images are uploaded and/or tagged. The example procedures of the present invention may modify those attributes and/or provide quality ratings associated with those attributes. Relevant attributes may be provided by a specific implementation of an example embodiment, may conform to those attributes disclosed in the incorporated reference, or may generally apply to any physical attribute of a user.

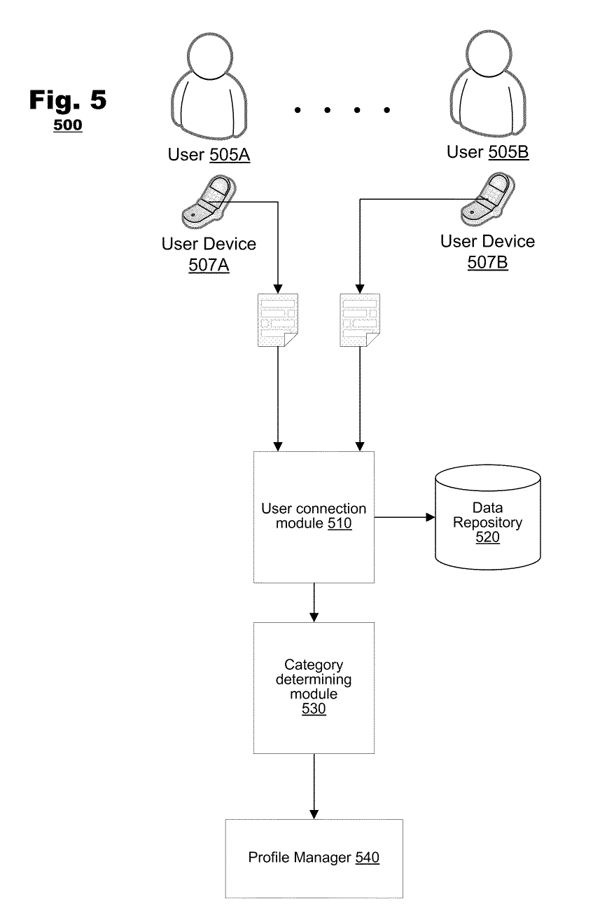

FIG. 5 illustrates another example embodiment of the present invention. As illustrated by users 505A and 505B, along with user devices 507A and 507B, the example system of FIG. 5 may accept files from a plurality of users in a distributed network context. Files may include images, videos, graphics, streaming data, or any other file. User device 507 may be any number of devices, including cell phones, smart phones, laptops, etc. The system of FIG. 5 may have a number of connection ports in the user connection module 510 that are capable of receiving incoming files from user devices. Files may be stored in a repository 520, and analyzed by a category determining module 530. There may be more than one repository and files may be organized by type, or stored together in a single set of repositories. Based on the analysis, the system may be configured to modify a user profile in the profile manager 540, based on data associated with the incoming file.

An example application of FIG. 5 may include a user with a cell phone camera who takes a picture of a person who the user finds attractive and believes to be older than the user. This user may then upload that picture to a website that collects such pictures (e.g., middle-aged attractive women). In addition to adding the picture to a repository of such images, a profile manager may increase a user's interest score for this category, in a preference profile that records such preferences (e.g., as described in the incorporated reference). The user connection module 510 may identify the uploading user based on any number of identifying characteristics known in the art (e.g., origin phone number, origin network ID/address, origin/sender email address, account log in/password, token, cookie, etc.)

The user connection module may interface with users in any number of ways, and determine categories in any number of ways. For example, each category may have a separate upload point (e.g., upload@category1.com and upload@category2.com) based on emails, urls, text or MMS message numbers, etc. There may also be a generic receive point to accept all uploads (e.g., images, movies, files, streaming data, etc.) and relevant categories may be determined by a category determining module 530, which may analyze any accompanying textual description or any other part of the uploaded image to determine what one or more preferences the file may fall within. In this way, a user's interaction with one or more content providing systems may allow for further refinement of that user's preference profile.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A method, comprising:
receiving a data upload from a user;
receiving descriptive data about contents of the data upload; and
modifying a preference profile associated with the user, based of the descriptive data.

2. The method of claim 1, wherein the data upload is an image.

3. The method of claim 2, wherein the descriptive data refers to physical attributes of a person depicted in the image.

4. The method of claim 1, further comprising:
providing descriptive options to the user, wherein the receiving descriptive data includes receiving option selections based on the descriptive options.

5. The method of claim 1, further comprising:
providing media content to a user based on the preference profile associated with the user.

6. The method of claim 2, wherein the image depicts the user, and wherein the preference profile is an attribute profile configured to store descriptive attributes of the user.

7. A system, comprising:
a user interface configured to receive a digital media from a user;
a tagging module configured to receive descriptive tags from the user related to contents of the digital media;
a media database configured to save the digital media in association with the descriptive tags; and
a profile manager configured to modify a user preference profile based on the descriptive tags received from the user.

8. The system of claim 7, wherein the media is an image.

9. The system of claim 8, wherein the descriptive data refers to physical attributes of a person depicted in the image.

10. The system of claim 7, wherein the tagging module is configured to provide descriptive options to the user, and configured to receive selections of the descriptive options.

11. The system of claim 7, further comprising:
a content module configured to provide content to a user based on the user preference profile associated with a particular user.

12. The system of claim 8, wherein the image depicts the user, and the user preference profile is an attribute profile stored in a database including descriptive attributes of the user.

13. A system for sharing digital media, comprising:
a database to store uploaded media;
a user interface configured to receive digital media from a plurality of users and store the digital media in the database;
the user interface configured to provide a plurality of descriptive tag options to a user;
the user interface configured to receive descriptive tag selections from a particular user about a particular image when the user uploads the particular image;
the user interface configured to provide images to the plurality of users from the database;
a processor configured to modify a user preference profile based on the tag selections from a user associated with the user preference profile and based on tags associated with images viewed by the user associated with the user preference profile.

14. The system of claim 13, wherein the user interface is configured to provide a user content that relates to a user preference profile for that user.

15. The system of claim 14, wherein the content is adult entertainment visual media.

16. The system of claim 13, wherein the processor is configured to match a first user with a second user based on each user's respective preference profile.
